(19) United States
(12) Patent Application Publication
(10) Pub. No.: US 2009/0102748 A1
(43) Pub. Date: Apr. 23, 2009

(54) Electronic display system

(75) Inventors: Douglas E. Stoyer, Colorado Springs, CO (US); Caleb C. Schmidt, Colorado Springs, CO (US)

Correspondence Address: LAW OFFICE OF DALE B. HALLING, 3595 FOUNTAIN BOULEVARD SUITE A2, COLORADO SPRINGS, CO, 80910, US

(73) Assignee: Skyline Products, Inc.

(21) Appl. No.: 11/977,011

(22) Filed: Oct. 22, 2007

(51) Int. Cl. G09G 3/04; G09G 3/06

(52) U.S. Cl. 345/33; 345/39; 340/815.53

(57) ABSTRACT

The invention relates to an electronic display system. The display system has a number of signs all linked together and to a controller by a mesh radio network. Each sign is made up of modular display units. Each display unit has a frame with at least two display sections (front and back) and clear frosted cover over the display sections. A pair of aperture stops is adjacent to the frosted covers. A circuit board has LEDs (Light Emitting Diodes) on both sides of the board is placed between the pair of aperture stops. Each sign is powered by a low voltage power source.

### BACKGROUND OF THE INVENTION

In a number of states gas stations are required to post the prices of the grades of gasoline on top of their pumps. Presently, this is done by placing a manually operated display on the pump. Unfortunately, this requires the gas station operator to physically go to each of the pumps and update the displays which is time consuming and takes the operator away from other tasks. In addition, the law in these states requires that the pump price concur at all times with the display on top of the pump. This can be difficult to coordinate when the gas station has numerous (eight or more) pumps. The pump price generally has to be changed inside the store, while the display has to be changed manually at the pump. Thus there exists a need for a pump display that overcomes these and other problems.

### BRIEF SUMMARY OF INVENTION

The invention relates to an electronic display system. The motivation for the invention was to solve the problems associated with displays on top of pumps required in a number of states, however the invention encompasses broader applications than the initial motivation. The display system has a number of signs all linked together and to a controller by a mesh radio network. Each sign is made up of modular display units. Each display unit has a frame with at least two display sections (front and back) and clear frosted cover over the display sections. A pair of aperture stops is adjacent to the frosted covers. A circuit board has LEDs (Light Emitting Diodes) on both sides of the board is placed between the pair of aperture stops.

### BRIEF DESCRIPTION OF THE SEVERAL VIEWS OF THE DRAWINGS

FIG. 1 is a perspective view of an electronic display unit in accordance with one embodiment of the invention;

FIG. 2 is a block diagram of an electronic display system in accordance with one embodiment of the invention;

FIG. 3 is an exploded view of an electronic display unit in accordance with one embodiment of the invention;

FIG. 4 is a front view of an electronic display unit of an electronic display unit in accordance with one embodiment of the invention;

FIG. 5 is a side view of an electronic display unit in accordance with one embodiment of the invention; and

FIG. 6 is a front view of a modular electronic display unit in accordance with one embodiment of the invention.

### DETAILED DESCRIPTION OF THE INVENTION

The invention relates to an electronic display system. The motivation for the invention was to solve the problems associated with displays on top of gasoline pumps required in a number of states, however the invention encompasses broader applications than the initial motivation. The display system has a number of signs all linked together and to a controller by a mesh radio network. Each sign is made up of modular display units. Each display unit has a frame with at least two display sections (front and back) and clear frosted cover over the display sections. A pair of aperture stops is adjacent to the frosted covers. A circuit board has LEDs (Light Emitting Diodes) on both sides of the board is placed between the pair of aperture stops.

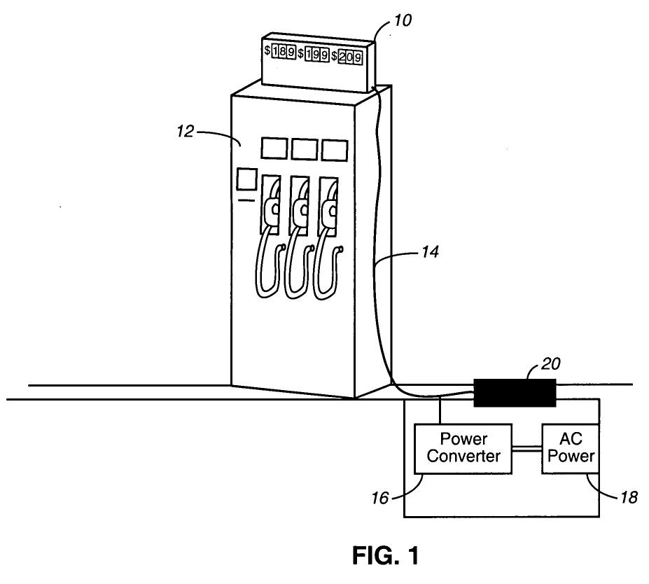

FIG. 1 is a perspective view of an electronic display unit 10 in accordance with one embodiment of the invention. The electronic display unit 10 is attached to the top of a gas station pump 12. The electronic display unit 10 has a cord 14 that provides low voltage power to the sign 10, such as 12 VDC. The cord 14 is connected to a power converter 16 that converts the incoming 120 VAC power 18 to a low voltage power. Commonly, the power box for the pump 12 is located below the ground next to the pump 12 under a cover 20, however the power box may not be below ground and may even be inside the pump.

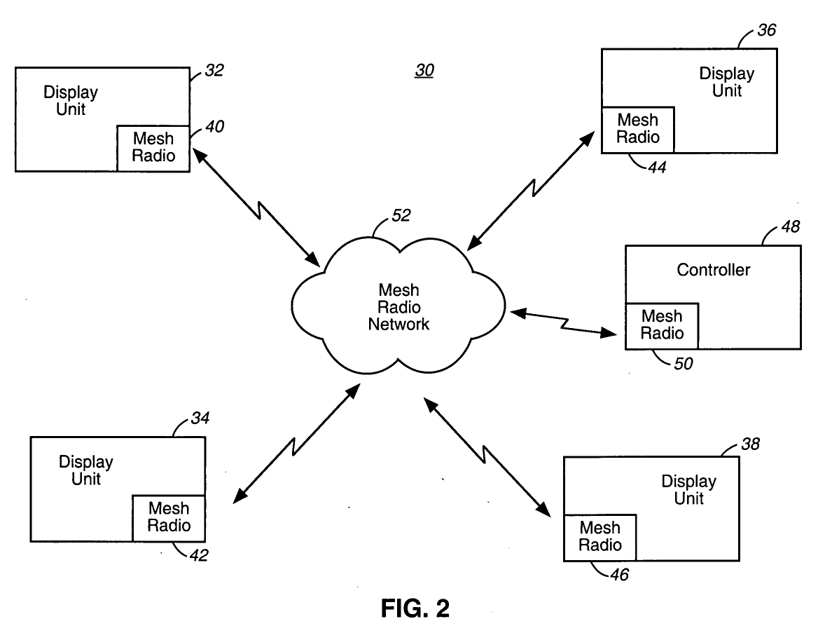

FIG. 2 is a block diagram of an electronic display system 30 in accordance with one embodiment of the invention. The system 20 has a number of display units (DU) 32, 34, 36, 38. Each display unit 32, 34, 36, 38 has a mesh radio 40, 42, 44, 46. The system 30 also has a controller 48 with a mesh radio 50. The mesh radios 40, 42, 44, 46 & 50 are all connected together by the mesh radio network 52. This is somewhat misleading, since the mesh radios actually form the mesh radio network. The advantage of mesh radios, or similar systems, is that the peer-to-peer arrangement allows signals to be routed a number of different paths. So in the case of a gas station, if a big truck is blocking the path between one of the signs (e.g., DU 32) and the controller 48, the signal can be routed to DU 36 first and then on to DU 32. This makes the system 30 very robust. Note this can also be important in the case of parking garages, where an RF signal from a controller to a sign may be blocked by the construction of the garage, but can be relayed by another sign. The controller 48 can individually control the displays for each of the display units 32, 34, 36, 38. So in the case of a gas station, the price at DU 34 can be changed separate from the price at DU 38.

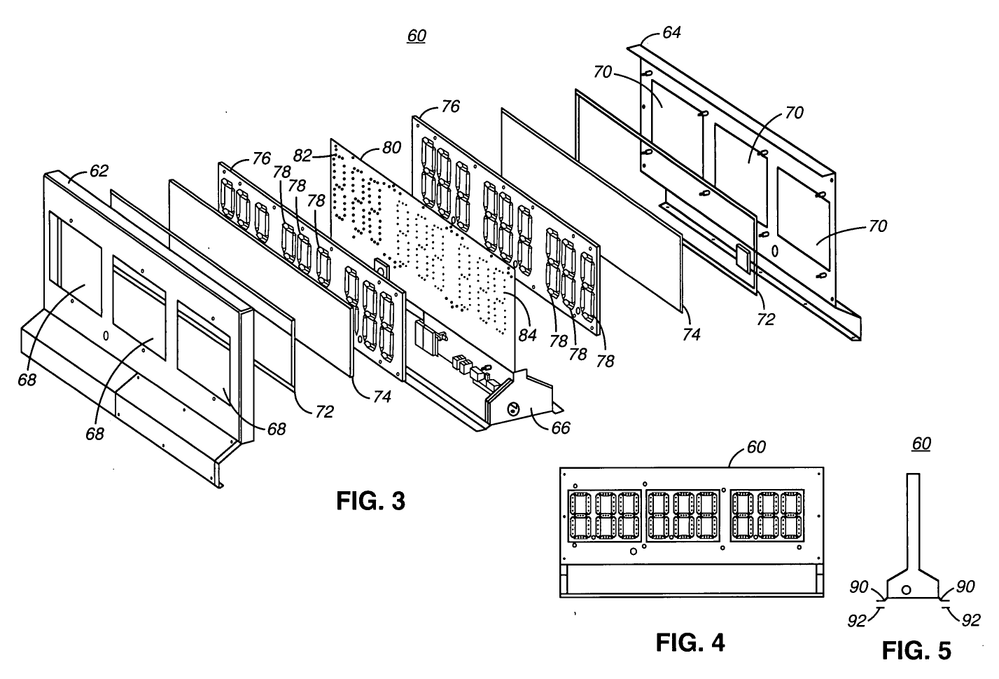

FIG. 3 is an exploded view of an electronic display unit 60 in accordance with one embodiment of the invention. The display unit 60 has a frame having a front face 62, a back face 64 and a base 66. The front face 62 has a number of display sections 68 and the back face 64 also has a number of display sections 70. Commonly the frame 62, 64, 66 is made of sheet metal or plastic. Next to the front face 62 and the back face 64 is a tape 72. The tape 72 holds a clear frosted cover 74 to the frame. The frosting tends to reduce the glare of the display. The clear frosted cover 74 may have a tinting cover applied or may having tinting incorporated into the cover 74. The tinting increases the contrast of the sign when in sunlight. Next is a pair of aperture stops 76 that have a number of seven segment cutouts 78. In one embodiment, the aperture stop 76 is formed from a micro-cellular, closed cell foam, such as polyurethane. The material for the aperture stop 76 should be easy to machine, be UV resistant and stable and thermally insulating. Polyurethane meets these requirements and can be die-cut to form the required apertures. In another embodiment, the aperture stop is injection molded. The aperture stop eliminates bleeding between different segments of the display. Sandwiched between the pair of aperture stops 76 is a printed circuit board 80. The printed circuit board 80 has surface mounted LEDs 82, 84 on both sides of the board 80. A single circuit board acts as a display for both the “front” and “back” display sections.

FIG. 4 is a front view of an electronic display unit 60 of an electronic display unit in accordance with one embodiment of the invention. This view shows how the sign 60 looks when assembled.

FIG. 5 is a side view of an electronic display unit 60 in accordance with one embodiment of the invention. This view shows flanges 90 in the frame base 66 that are used to mount the display 60 to a gasoline pump. Commonly the flanges 90 are adhered to the pump by double sided tape 92 or some other adhesive.

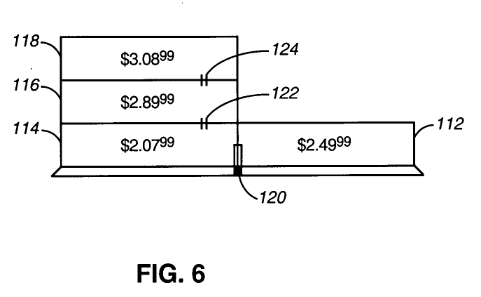

FIG. 6 is a front view of a modular electronic display unit 110 in accordance with one embodiment of the invention. The modular electronic display unit 110, has four separate modules 112, 114, 116, 118. The modules 112, 114, 116, 118 have electrical and mechanical interconnects 120, 122, 124. The modular design allows the displays to expand to accommodate additional information that needs to be displayed.

Note that while the present invention has been described with respect to pump top displays, the display units could be variable message displays or other gas price signs such as canopy signs, roadside signs, etc.

Thus there has been described an electronic sign system that solves the needs for gas pump displays. In addition, the electronic sign system can be used for a number of electronic signs. The system provides a low cost and robust sign system.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An electronic display, comprising:
a frame having a display section; and
an aperture stop within to the frame.

2. The display of claim 1, further including a clear frosted cover fitting in the display section;

3. The display of claim 2, further including a printed circuit board having a plurality of surface mounted LEDs adjacent to the aperture stop.

4. The display of claim 2, further including a tinting applied to the clear frosted cover.

5. The display of claim 1, wherein the aperture stop is made of a polyurethane foam.

6. The display of claim 3, wherein the frame has two opposing display sections.

7. The display of claim 6, wherein the printed circuit board has a first set of LEDs mounted on a first side of the printed circuit board and has a second set of LEDs mounted on a second side of the printed circuit board.

8. An electronic display system, comprising:
a plurality of display units; and
a mesh radio network providing communication between each of the plurality of display units.

9. The system of claim 8, further including a controller coupled to the mesh radio network.

10. The system of claim 9, wherein the plurality of display units includes a variable message sign.

11. The system of claim 9, wherein the plurality of display units includes a pump top sign.

12. The system of claim 11, wherein the plurality of display units includes another gas price sign.

13. The system of claim 11, wherein each of the display units comprises:
a frame having a display section; and
a aperture stop fitting within the frame.

14. The system of claim 13, wherein the frame has a flat mounting flange.

15. The system of claim 14, wherein the flat flange is adhered to a surface to mount the display unit.

16. The system of claim 8, wherein each of the plurality of display units are modular.

17. The system of claim 9, wherein each of the plurality of display units are individually controllable.

18. An electronic display system, comprising:
a plurality of display units;
a mesh radio network providing communication between each of the display units; and
a controller coupled to the mesh radio network.

19. The system of claim 18, wherein the plurality of display units are each comprised of a modular display section.

20. The system of claim 18, wherein each of the display units comprises:
a frame having a display section; and
an aperture stop within to the frame.

21. The display of claim 20, wherein the frame has two display sections on opposite sides of the frame.

22. The display of claim 21, further including a printed circuit board having a first set of LEDs mounted on a first side of the printed circuit board and has a second set of LEDs mounted on a second side of the printed circuit board.
